(19) United States
(12) Patent Application Publication
(10) Pub. No.: US 2014/0032346 A1
(43) Pub. Date: Jan. 30, 2014

(54) METHOD AND SYSTEM FOR CONTROLLING MOBILE DATA TERMINALS

(71) Applicant: Tencent Technology (Shenzhen) Company Limited, Shenzhen (CN)

(72) Inventors: Taoli Hong, Shenzhen (CN); Peiku Li, Shenzhen (CN); Anfeng Tan, Shenzhen (CN)

(73) Assignee: Tencent Technology (Shenzhen) Company Limited, Shenzhen (CN)

(21) Appl. No.: 14/012,951

(22) Filed: Aug. 28, 2013

Related U.S. Application Data
(63) Continuation of application No. PCT/CN2013/079138, filed on Jul. 10, 2013.

(30) Foreign Application Priority Data
Jul. 12, 2012 (CN) 201210241231.2

(51) Int. Cl. G06Q 20/32

(52) U.S. Cl. CPC G06Q 20/3224
USPC 705/18; 705/16

(57) ABSTRACT

The present invention provides a method and system for controlling a mobile data terminal, comprising: receiving an instruction execution request from the mobile POS terminal; in response to receiving the instruction execution request, determining whether the instruction execution request contains current location information associated with the mobile POS terminal; if not, executing a real-time location acquisition procedure to proactively obtain the current location information associated with the mobile POS terminal; if yes, executing a real-time location verification procedure to confirm the current location information contained in the instruction execution request; and determining whether the mobile POS terminal is located in a pre-determined region according to the current location information that has been verified or proactively obtained.

### RELATED APPLICATIONS AND PRIORITY CLAIMS

This application is a continuation application of PCT Patent Application No. PCT/CN2013/079138, entitled “Method and System for Controlling Mobile Data Terminals”, filed Jul. 10, 2013, which claims priority to Chinese Patent Application No. 201210241231.2, entitled “Method and System for Controlling Mobile Data Terminals”, filed on Jul. 12, 2012, both of which are incorporated herein by reference in their entireties.

### TECHNICAL FIELD

The present invention relates to monitoring technology, and in particular, to a method and system for controlling a mobile data terminal, such as a mobile point-of-sale/service (POS) terminal

### BACKGROUND

Mobile data terminals include mobile POS terminals such as retail POS terminals and various logistical POS terminals. The mobile POS terminals can be POS terminals that have wireless network access and can be moved from location to location. The wireless access POS terminals are widely applied in industries such as logistics, insurance, package delivery, mobile retail (e.g., door-to-door sales, on-site service or goods delivery, mobile food trucks, mobile service trucks, etc.), mobile check-out (e.g., roaming express checkout on the store floor), etc. because of the portability and good mobility thereof.

The mobile data terminals are usually distributed to service personnel (e.g., service agents or operators) for use in multiple different regions or locations. The service personnel holding the mobile data terminals accept payments for goods and services provided to clients and customers by swiping suitable payment cards through the mobile data terminals. However, during the process of a service agent providing the card-swiping service through a mobile data terminal to a client or customer, the involved operations cannot be monitored. In addition, the mobility of the unmonitored mobile data terminal will also bring a very high risk of unauthorized or illegal activities or use. For example, a service agent may take a mobile data terminal intended for use in the insurance service industry to another place to achieve the illegal purposes of money laundering, illegal cashing, etc. through the operation of card-swiping service. The unmonitored mobile POS terminals thus raise a security concern.

### SUMMARY

On this basis, a method for controlling a mobile data terminal which can improve security is provided.

In addition, a system for controlling a mobile data terminal which can improve security is provided.

A method for controlling a mobile data terminal, comprises the steps of: acquiring an instruction execution request from a mobile data terminal, with the instruction execution request comprising an operation instruction triggered by the mobile data terminal and location information thereof; and determining whether the mobile data terminal is located in a pre-determined region according to the location information in the instruction execution request, and if not, then declining to execute the operation instruction.

A system for controlling a mobile data terminal, comprises a mobile data server, wherein the mobile data server comprises: a request acquisition module for acquiring an instruction execution request from a mobile data terminal, with the instruction execution request comprising an operation instruction triggered by the mobile data terminal and location information thereof; and a validity checking module for determining whether the mobile data terminal is located in a pre-determined region according to the location information in the instruction execution request, and if not, then refusing to execute the operation instruction.

In some embodiments, the above-mentioned method and system for controlling a mobile data terminal, further includes one or more of the following features:

In some embodiments, to control a mobile point-of-sale (POS) terminal, a mobile data server (e.g., an operation server) receives an instruction execution request from the mobile POS terminal, the instruction execution request specifying an operation instruction generated at the mobile POS terminal; in response to receiving the instruction execution request, the operation server determines whether the instruction execution request contains current location information associated with the mobile POS terminal; in accordance with a determination that the instruction execution request does not contain current location information associated with the mobile POS terminal: the operation server executes a real-time location acquisition procedure to proactively obtain the current location information associated with the mobile POS terminal; in accordance with a determination that the instruction execution request contains current location information associated with the mobile POS terminal: the operation server executes a real-time location verification procedure to confirm the current location information contained in the instruction execution request; and the operation server determines whether the mobile POS terminal is located in a pre-determined region according to the current location information that has been verified or proactively obtained.

In some embodiments, after acquiring location information about the place where the mobile data terminal (e.g., the mobile POS terminal) is currently located, the mobile data terminal initiates an instruction execution request according to a triggered operation instruction and the location information. The operation server determines whether the location where the mobile data terminal is currently located is in a pre-determined region according to the location information thereof in the instruction execution request. If the mobile data terminal is not in the pre-determined region currently, then the operation instruction will not be executed. Thus, the risk that the mobile data terminal moves to another region for performing other purposes differing from the original intended purposes can be reduced. Furthermore, through monitoring the mobile data terminal according to the location information, security can be improved.

### BRIEF DESCRIPTION OF THE DRAWINGS

FIG. 1 is a block diagram illustrating an operating environment of a mobile data terminal and a mobile data server, in accordance with some embodiments.

FIG. 2 is a block diagram of an exemplary system for controlling a mobile data terminal, in accordance with some embodiments.

FIGS. 3A-3G are flow charts of an exemplary method for controlling a mobile data terminal, in accordance with some embodiments.

FIG. 4 is a block diagram of a system for controlling a mobile data terminal, in accordance with some embodiments.

FIG. 5 is a block diagram of a system for controlling a mobile data terminal, in accordance with some embodiments.

FIG. 6 is a block diagram of a validity checking module in accordance with some embodiments.

FIG. 7 is a time sequence diagram for communication between a mobile data terminal and a database of a mobile data server, in accordance with some embodiments.

FIG. 8 is a time sequence diagram of checking the validity of the location information by a mobile data server, in accordance with some embodiments.

FIG. 9 is a schematic diagram of an exemplary use case in which a service agent and a consumer are engaged in a card-swiping payment operation, in accordance with some embodiments.

FIG. 10 is a time sequence diagram of providing location based service information to a mobile data terminal, in accordance with some embodiments.

### DETAILED DESCRIPTION

Today, mobile merchants are become increasingly prevalent. Many traditional merchants (e.g., restaurants, grocery stores, department stores, hair dressers, nail salons, etc.) are opting to sell goods and services at locations other than their usual brick and mortar business premises. In addition, door-to-door or on-site delivery of goods and services to customers has also become popular when coupled with the convenience of online and/or telephone ordering services. Mobile data terminals such as wireless point-of-sale and point-of-service (POS) terminals are increasingly useful in this mobile commerce context. A mobile POS terminal carried by a service agent allows the service agent to accept payment from a customer for goods and services delivered to the customer by swiping a payment card (e.g., a credit card, debit card, a gift card, etc.) through the mobile POS terminal, and/or by communicating (e.g., via BlueTooth™ or other wireless protocols) with an electronic payment device (e.g., a smart phone with an acceptable payment software application). Furthermore, mobile POS terminals also find use in logistics and shipping which involve hand-off and acceptance of goods and/or payments during package pick-up, delivery, and custody transitions during transit.

Sometimes, it is desirable to monitor the current location of the mobile data terminals (e.g., the mobile POS terminals), and determine whether a requested operation (e.g., a purchase or payment operation, a cashing out operation, etc.) should be permitted or not. For example, if a service agent has only obtained the proper license to operate in a particular geographic area, it is desirable to verify that the current location of the mobile POS terminal used by the service agent is within the authorized geographic area when a payment transaction is requested.

Sometimes, even if the mobile POS may be permitted to operate in multiple geographic locations, it may be desirable to implement different operation procedures for the different geographic locations. For example, depending on the current location of the mobile data terminal, it is sometimes desirable to automatically select a different procedure, e.g., authentication procedure, payment procedure, payment form, tax amount, price, etc., to carry out a permitted operation, due to the differences in the fraud statistics, business environment, standard of living, tax rates, etc., associated with the different geographic locations.

Sometimes, mobile POS terminals may be realized by many different kinds of hardware devices, and the capabilities of the mobile POS terminals may not be identical across different merchants and/or service agents. In order to accommodate the high variability in the capabilities of the POS terminal, it is desirable to design an operation server that adapts to the different location capabilities of the mobile POS terminals, and provides suitable monitoring and verification of location information for the different mobile POS terminals.

Sometimes, some mobile POS terminals may be subject to tempering and/or hardware or software errors. As a result, the location information provided by the mobile POS may not be accurate. Therefore, it is desirable to provide suitable verification procedures of location information received from the mobile POS before requested operations are executed.

Sometimes, it is desirable that the operation server utilizes the location information gathered from the mobile POS terminals to generate and provide location-specific service information and/or recommendations to the customer that is interacting with the mobile POS terminals.

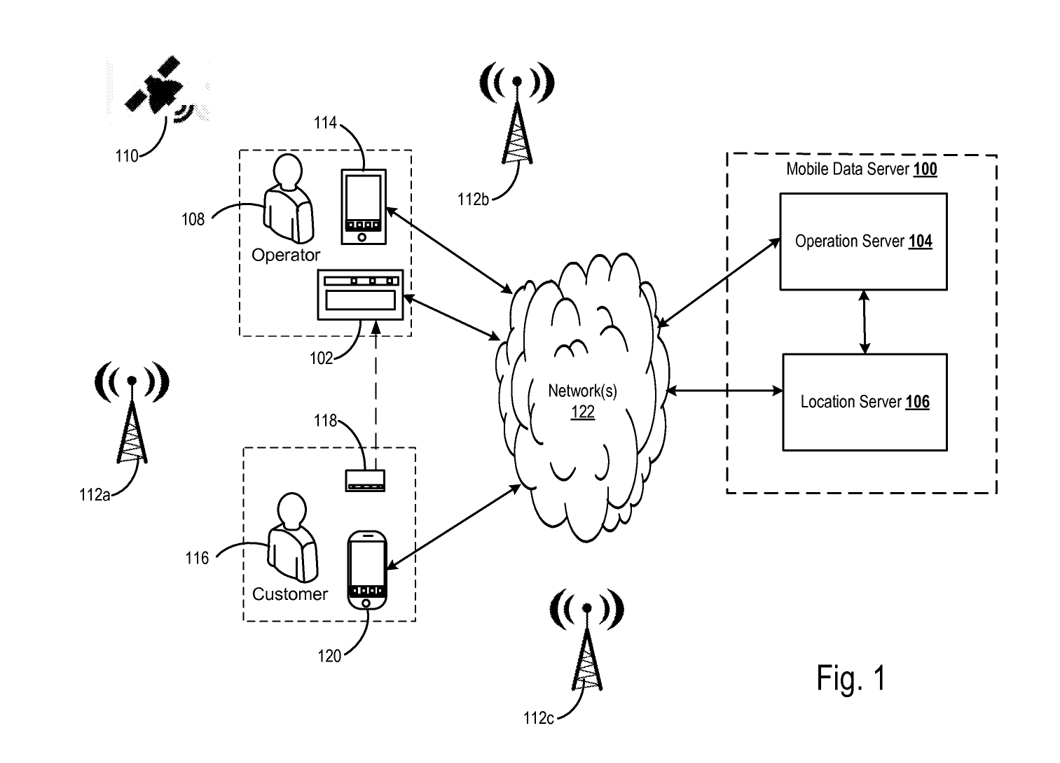

FIG. 1 is a blog diagram illustrating an exemplary environment in which a mobile data terminal (e.g., a mobile POS terminal 102) and a mobile data server 100 (e.g., including an operation server 104 and, optionally, a location server 106) operate and interact with one another.

As shown in FIG. 1, the mobile POS terminal 102 is carried by an operator 108 (e.g., an authorized service agent for a business, such as a salesperson, a cashier, a delivery person, etc.). In some embodiments, the mobile POS terminal is a computing device that has user interfaces for receiving user input (e.g., a hardware or software keyboard or keypad, a touch-sensitive display, a touch pad, etc.), reading a payment instrument (e.g., a payment card reader, a barcode scanner, a BlueTooth™ electronic coupon reader, etc.), and providing information (e.g., a display screen, a speaker, a printer, etc.). In some embodiments, the mobile POS terminal 102 is implemented on a desktop computer, a tablet computer, a mobile telephone, a smartphone, a personal digital assistant (PDA), or another electronic computing device with or without additional software and hardware attachments (e.g., a card-reader, a barcode scanner). In some embodiments, the mobile POS terminal is coupled to a positioning device, such as a Global Positioning System (GPS) which provides real-time geographic coordinates (e.g., latitude and longitude coordinates) of the mobile POS terminal from one or more nearby satellites 110. In some embodiments, the mobile POS terminal is configured to access a mobile communication network (e.g., a cellular telephone network), and determine its geographic location based on its relative distance to nearby cellular base stations 112. In some embodiments, the operator 108 of the mobile POS terminal 102 optionally carries a mobile device 114 (e.g., a smartphone, a cellular phone, a tablet computer, etc.) that has access to a mobile communication network. In some embodiments, the mobile POS terminal 102 is optionally coupled to the mobile device 114 through a short-range wired or wireless communication protocol (e.g., BlueTooth™), and obtains location information from the mobile device 114.

As shown in FIG. 1, when the operator 108 carries out a transaction with a customer 116, the operator 108 registers a transaction request in the mobile POS terminal 102, e.g., by typing the necessary input or selecting the appropriate menu options provided by the POS terminal 102. For example, in some embodiments, for a payment transaction, the operator 108 takes a payment card 118 (e.g., a credit card, a gift card, a special ID card, etc.) provided by the customer 116 and swipes the card 118 through a card reader of the mobile POS terminal 102. For another example, in some embodiments, the operator 108 optionally allows the customer 116 to transfer a payment or electronic coupon using a mobile device 120 (e.g., a smartphone, a cellular phone, a tablet computer, etc.) carried by the customer 116. In some embodiments, the customer 116 optionally provides an acknowledgement for receipt of goods, package, service, cash, and/or credit to the mobile POS terminal 102 by providing a personal signature or passcode into the mobile POS terminal 102.

As shown in FIG. 1, when necessary information for a transaction has been provided by the customer 116 and the operator 108, the mobile POS terminal 102 communicates with the operation server 104 to submit a transaction request (e.g., an instruction execution request) through one or more networks 122 (e.g., GSM, EDGE, CDMA, TDMA, Bluetooth, Wi-Fi, VoIP, Wi-MAX, or any other suitable wireless networks). In some embodiments, the operation server 104 verifies the information contained in the transaction request to determine if the transaction is authorized and whether the execution of the requested transaction should proceed. In some embodiments, the operation server 104 obtains and/or verifies the current location of the mobile POS terminal 102 before authorizing the requested transaction. In some embodiments, the operation server communicates directly with the location server 106, the mobile device 120, the mobile device 114, and/or the mobile POS terminal 102 to obtain and/or verify the current location of the mobile POS terminal. More details of how the operation server 104 obtains and verifies the location information and carries out the requested transactions are provided below.

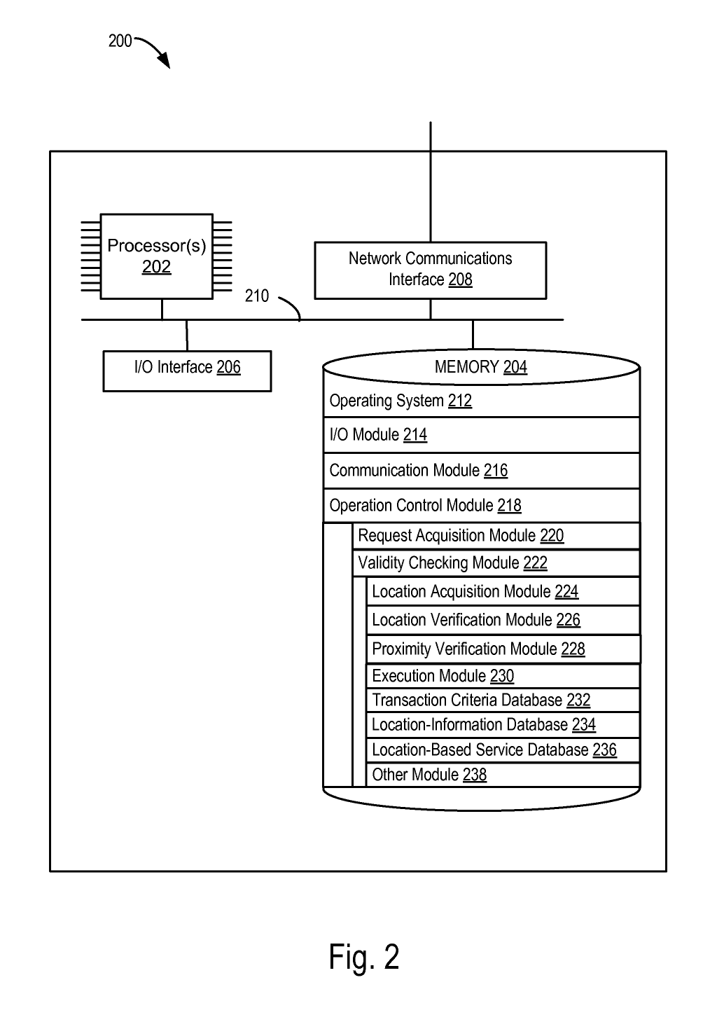

FIG. 2 is a block diagram of a system 200 that monitors and controls the mobile data terminals (e.g., mobile POS terminal 102 of FIG. 1) in accordance with some embodiments. In some embodiments, the system 200 serves as a mobile data server 100, including the operation server 104 and the location server 106. In some embodiments, independent systems analogous to the exemplary system 200 are used to provide the operation server 104 and the location server 106, respectively.

As shown in FIG. 2, the system 200 includes one or more processing units (or “processors”) 202, memory 204, an input/output (I/O) interface 206, and a network communications interface 208. These components communicate with one another over one or more communication buses or signal lines 210. In some embodiments, the memory 204, or the computer readable storage media of memory 204, stores programs, modules, instructions, and data structures including all or a subset of: an operating system 212, an I/O module 214, a communication module 216, and an operation control module 218. The one or more processors 202 are coupled to the memory 204 and operable to execute these programs, modules, and instructions, and reads/writes from/to the data structures.

In some embodiments, the processing units 202 include one or more microprocessors, such as a single core or multi-core microprocessor. In some embodiments, the processing units 202 include one or more general purpose processors. In some embodiments, the processing units 202 include one or more special purpose processors. In some embodiments, the processing units 202 include one or more personal computers, mobile devices, handheld computers, tablet computers, or one of a wide variety of hardware platforms that contain one or more processing units and run on various operating systems.

In some embodiments, the memory 204 includes high-speed random access memory, such as DRAM, SRAM, DDR RAM or other random access solid state memory devices. In some embodiments the memory 204 includes non-volatile memory, such as one or more magnetic disk storage devices, optical disk storage devices, flash memory devices, or other non-volatile solid state storage devices. In some embodiments, the memory 204 includes one or more storage devices remotely located from the processing units 202. The memory 204, or alternately the non-volatile memory device(s) within the memory 204, comprises a computer readable storage medium.

In some embodiments, the I/O interface 206 couples input/output devices, such as displays, a keyboards, touch screens, speakers, and microphones, to the I/O module 214 of the system 200. The I/O interface 206, in conjunction with the I/O module 214, receive user inputs (e.g., voice input, keyboard inputs, touch inputs, etc.) and process them accordingly. The I/O interface 206 and the user interface module 214 also present outputs (e.g., sounds, images, text, etc.) to the user according to various program instructions implemented on the system 200.

In some embodiments, the network communications interface 208 includes wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends RF signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol. The network communications interface 208 enables communication between the system 200 with networks, such as the Internet, an intranet and/or a wireless network, such as a cellular telephone network, a wireless local area network (LAN) and/or a metropolitan area network (MAN), and other devices. The communications module 216 facilitates communications between the system 200 and other devices (e.g., the mobile POS terminal 102, the mobile device 114, and the mobile device 120) over the network communications interface 208.

In some embodiments, the operating system 202 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

In some embodiments, the system 200 is implemented on a standalone computer system. In some embodiments, the system 200 is distributed across multiple computers. In some embodiments, some of the modules and functions of the system 200 are divided into a server portion and a client portion, where the client portion resides on a user device (e.g., mobile POS terminal 102, mobile device 114, and/or mobile device 120) and communicates with the server portion residing one a server device through one or more networks. It should be noted that the system 200 is only one example of the operation server system, and that the system 200 may have more or fewer components than shown, may combine two or more components, or may have a different configuration or arrangement of the components. The various components shown in FIG. 2 may be implemented in hardware, software, firmware, including one or more signal processing and/or application specific integrated circuits, or a combination of thereof.

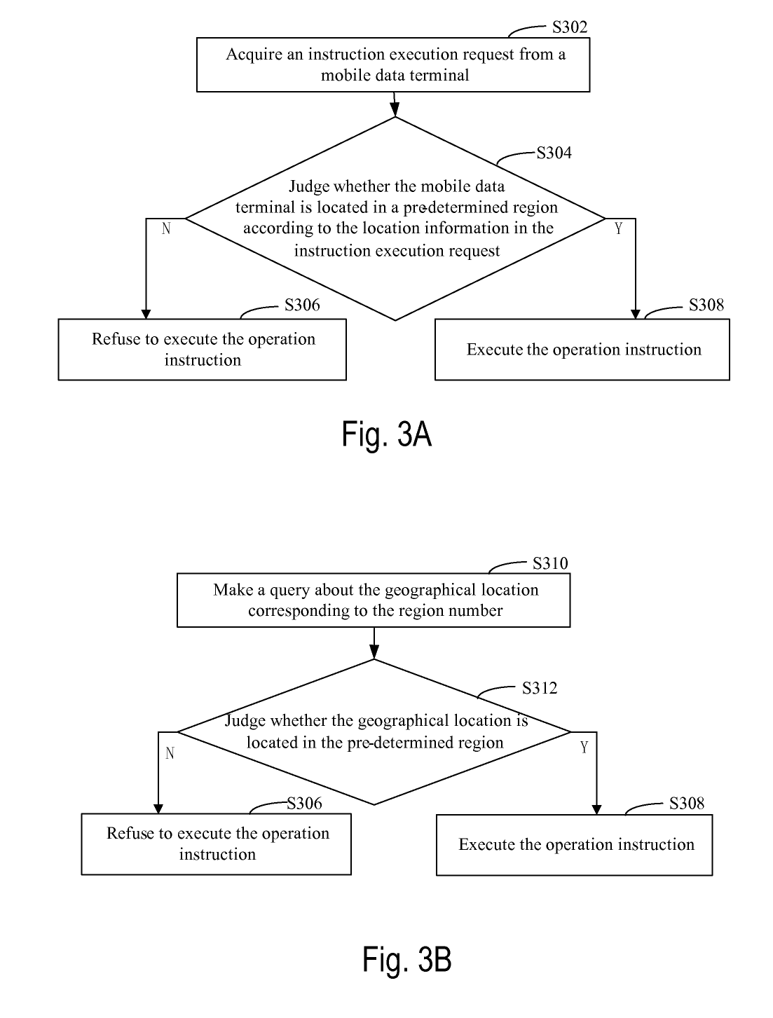

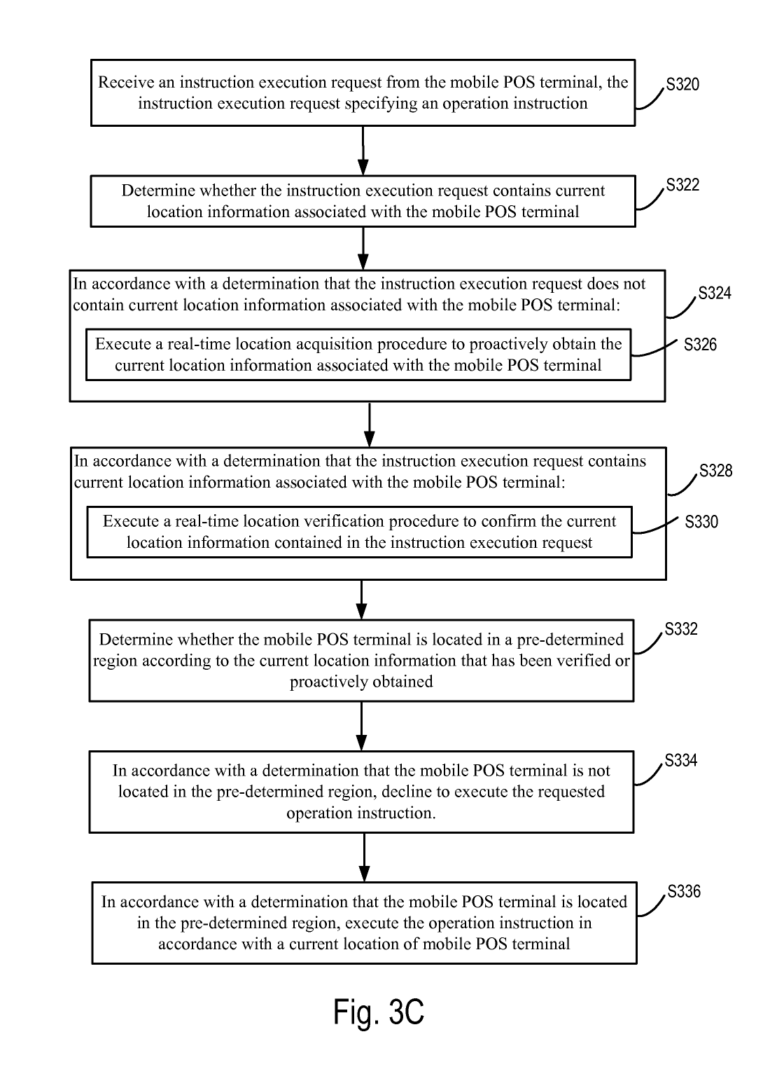

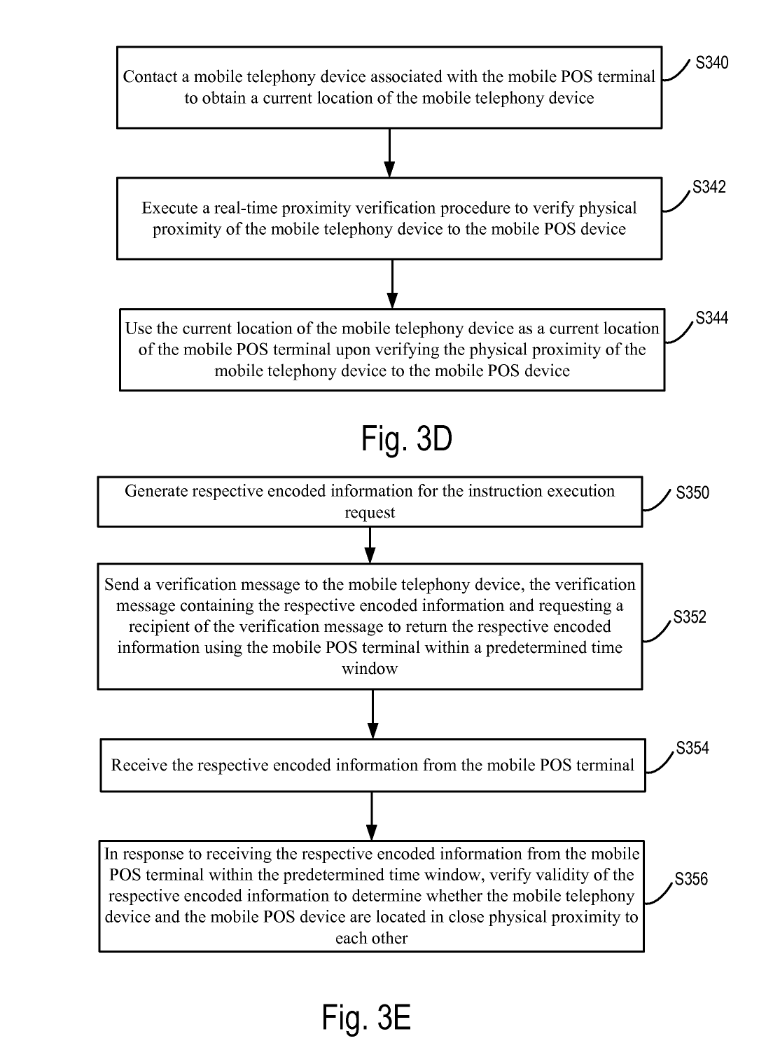

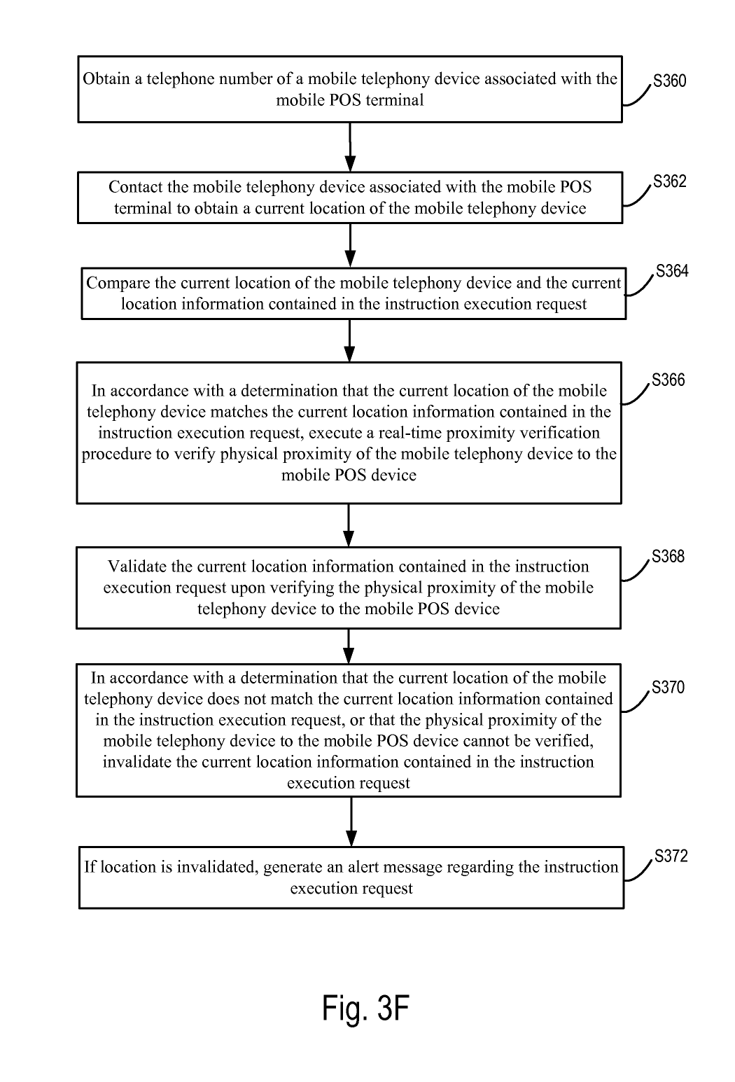

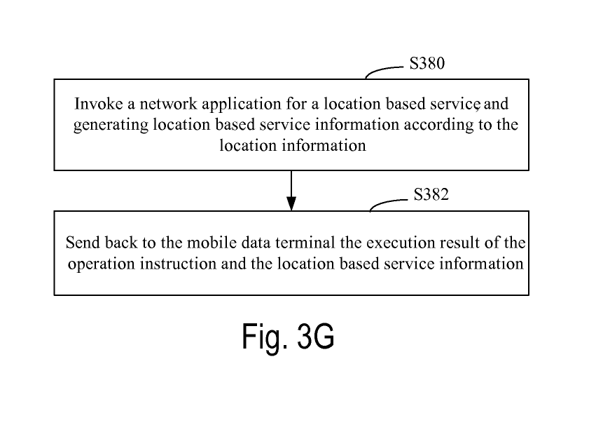

As shown in FIG. 2, the system 200 stores the operation control module 218 in the memory 204. In some embodiments, the operation control module 218 further includes the followings sub-modules, or a subset or superset thereof: a request acquisition module 220, and a validity checking module 222. In some embodiments, the validity checking module 222 further includes a location acquisition module 224, a location verification module 226, a proximity verification module 228, and execution module 230. In addition, each of these sub-modules has access to one or more of the following data structures and data sources of the operation control module 218, or a subset or superset thereof: a transaction criteria database 232 containing the authorized transactions (e.g., payment, cashing, confirmation, etc.) and transaction execution criteria (e.g., location-criteria, authentication criteria, etc.), a location information database 234 of historic location information associated with mobile data terminals, a location-based service database 236 containing locale-specific information and services. In some embodiments, the operation control module optionally include one or more other modules 238 (e.g., a network application module) to provide other related functionalities described herein. More details on the structures, functions, and interactions of the sub-modules and data structures of the operation control module 218 are provided with respect to FIGS. 3A-10, and accompanying descriptions.

FIG. 3A is a flow chart of an exemplary process for controlling execution of requested operations based on a current location of a mobile data terminal (e.g., a mobile POS terminal 102 in FIG. 1). The process is optionally performed by a mobile data server (e.g., the mobile data server 100 or the operation server 104 in FIG. 1).

As shown in FIG. 3A, in one embodiment, a method for controlling a mobile data terminal comprises the steps of:

step S302, acquiring an instruction execution request from a mobile data terminal For example, the instruction execution request optionally includes a request to authorize a credit card payment transaction, a request to transfer funds to a specified account, etc.

In some embodiments, the instruction execution request comprises an operation instruction triggered by the mobile data terminal and location information of the mobile data terminal. The instruction execution request initiated by the mobile data terminal is acquired by the mobile data server, and then an operation input by the mobile data terminal is determined according to the operation instruction triggered by the mobile data terminal in the instruction execution request; and the location where the mobile data terminal is located is obtained according to the location information thereof contained in the instruction execution request. In some embodiments, the instruction execution request does not include explicit location information for the mobile data terminal, but instead identifies the mobile data terminal, and optionally, the operator and/or the customer of the mobile data terminal. As will be described in more details later, the mobile data server optionally obtains the location information in real-time through other location acquisition and location verification procedures.

In some embodiments, the location information is used for identifying the location where the mobile data terminal is currently located. In some embodiments, a positioning function is added into the mobile data terminal to acquire the location information about the place where the mobile data terminal is currently located so that the mobile data server can monitor the location of the mobile data terminal.

In some embodiments, before the above-mentioned step S302, the mobile data terminal performs operations comprising: obtaining the longitude and latitude of the place where the mobile data terminal is located by carrying out positioning thereof with a satellite positioning system (e.g., a GPS system) provided in the mobile data terminal; and initiating the instruction execution request to the mobile data server, where the instruction execution request is prepared by the mobile data terminal according to the operation instruction triggered by the mobile data terminal and the longitude and latitude obtained by the satellite positioning system.

In some embodiments, a satellite positioning module is externally connected to or provided in the mobile data terminal, thus achieving positioning of the mobile data terminal by means of the satellite positioning system provided by the satellite positioning module. Particularly, the satellite positioning system can be a Global Positioning System (GPS) or an Assisted Global Positioning System (AGPS). The location information obtained by means of the satellite positioning system is the longitude and latitude of the place where the mobile data terminal is located.

In some embodiments, in the process of actual operation, the mobile data terminal is positioned regularly (e.g., periodically every minute or every ten minutes) to obtain the location information thereof, and the location information is continuously or periodically uploaded to a database (e.g., a database of the location server 106 of FIG. 1) in the background.

In some embodiments, an operation instruction is generated through an input for initiating a card-swiping payment operation or other operations such as a pre-authorization operation, etc. on the mobile data terminal. At this moment, in response to the input, the mobile data terminal packages the current longitude and latitude obtained by the latest self-positioning process, and the operation instruction to generate an instruction execution request. The mobile data terminal then sends the instruction execution request toward the mobile data server (e.g., the operation server 104 in FIG. 1) on the backend.

In some embodiments, before the above-mentioned step S302, the mobile data terminal performs operations comprising: obtaining the region number or cell number of the region or cell in which the mobile data terminal is located. In some embodiments, the region number or cell number is obtained through the communication of the mobile data terminal in a mobile communication network. For example, in a cellular telephone network, each base station communicates with nearby mobile data terminals using a specific frequency and signal signature. Based on the locations of the base stations near a mobile data terminal, the location of the mobile data terminal can be determined. In some embodiments, the mobile data terminal sends the instruction execution request according to the operation instruction triggered by the mobile data terminal and the region number or cell number associated with the base stations near the mobile data terminal.

In some embodiments, if the mobile data terminal is a mobile communication device (e.g., a smartphone), then when the mobile data terminal is communicating through a mobile communication network, the mobile data terminal needs to register with a nearby base station of the mobile communication network. Since each base station has corresponding region signal information, in this communication process, the mobile terminal acquires the region signal information such as the corresponding service provider, region or cell number, etc. Through communicating with the base station(s), the mobile data terminal transmits communication data to a switch in the communication network which then forwards the communication data to a recipient device (e.g., the operation server 104 or the location server 106 in FIG. 1). Thus, the mobile terminal acquires the region number of the region where the mobile terminal is located through the communication in the mobile communication network, and identifies the location where the mobile terminal is located by taking the region number as location information.

In some embodiments, the mobile data terminal generates an operation instruction in response to an operation input provided to the mobile data terminal, e.g., by the operator of the mobile data terminal. In some embodiments, the mobile data terminal packages the currently acquired region number and the operation instruction to generate an instruction execution request. The mobile data terminal then sends the instruction execution request toward a mobile data server (e.g., the mobile data server 100 or the operation server 104 in FIG. 1) on the backend.

In some embodiments, in step S304, the mobile data server judges or determines whether the mobile data terminal is located in a pre-determined region according to the location information thereof contained in the instruction execution request. In some embodiments, if mobile data server determines that the mobile data terminal is not located within the pre-determined region, the process proceeds to step S306, and if the mobile data server determines that the mobile data terminal is located within the pre-determined region, the process proceeds to step S308.

In some embodiments, the pre-determined region is a pre-determined region in which the use of the mobile data terminal is permitted or authorized. For example, suppose that a particular business is licensed to operate only within one particular city. Then, the mobile data server uses that particular city as the pre-determined region for authorizing the instruction execution requests received from mobile data terminals associated with that particular business. In some embodiments, the pre-determined region optionally includes two or more continuous and/or disconnected sub-regions. After receiving the instruction execution request initiated by the mobile data terminal, the mobile data server determines the validity of the operation input by the mobile data terminal based on whether the input operation has occurred in the pre-determined region. In accordance with the location information, if it is determined that the location where the mobile data terminal is currently located when inputting the operation, is within the pre-determined region, then it indicates that the input operation is valid and execution of the corresponding operation instruction is authorized; and if it is determined that the location where the mobile terminal is located when inputting the operation, is not within the pre-determined region, then, the execution of the corresponding operation instruction will be forbidden in order to reduce the associated risk.

In some embodiments, in the above-mentioned step S304, after the mobile data terminal is positioned and the location information thereof is obtained, whether the mobile data terminal is located in the pre-determined region can also be judged directly according to the location information. In some embodiments, if the mobile data server (e.g., the operation server 104 or the location server 106 in FIG. 1) determines that the mobile data terminal is not located within the pre-determined region, the mobile data terminal optionally generates alarm information and sends an alarm message back to the mobile data terminal, e.g., to alert the operator of the mobile data terminal that he or she has moved outside of the authorized working area. In some embodiments, if the mobile data server determines that the mobile data terminal is within the pre-determined region, the positioning and monitoring of the mobile data terminal will be continued.

In some embodiments, monitoring the mobile data terminal is achieved according to the location information, so as to further improve the security of the mobile data terminal.

As shown in FIG. 3B, in some embodiments, the specific process of the above-mentioned step S304 comprises:

Step S310, making a query about the geographical location corresponding to the region number that has been received in the instruction execution request.

In some embodiments, if the mobile data terminal is a mobile device (e.g., a smartphone, a cellular phone, etc.), then the corresponding location information provided by the mobile data terminal is optionally provided in the form of region number or cell number in a wireless communication network (e.g., a cellular network). Correspondingly, when determining the validity of the input of the mobile data terminal according to the location information thereof, the mobile data server makes the determination according to the region number, and obtains the geographical location corresponding to the region number according to the region number contained in the instruction execution request received from the mobile data terminal.

In step S312, the mobile data server determines whether the obtained geographical location is located within the pre-determined region, and if not, the process proceeds to step S306, and if yes, the process proceeds to step S308, as described above with respect to FIG. 3A.

In some embodiments, whether the mobile terminal is located in the pre-determined region is determined according to the geographical location obtained based on the region number. Based on the determination, the mobile data server verifies whether the mobile terminal is located in the pre-determined region for which the use of the mobile data terminal has been pre-authorized.

In step S306, the mobile data server declines to execute the operation instruction requested in the instruction execution request.

In the step S308, the mobile data server executes the operation instruction requested in the instruction execution request.

As described above, in some embodiments, the mobile data terminal is equipped with a self-positioning capability (e.g., using GPS). In some embodiments, the mobile data terminal has access to a mobile communication network (e.g., a cellular network), and can provide a region number or cell number of a nearby base station which is then used by the mobile data server to determine the location of the mobile data terminal. In some embodiments, the mobile data terminal's location is monitored continuously by the mobile data server. In some embodiments, the mobile data terminal only provides its location information when submitting an instruction execution request to the mobile data server. In some embodiments, the mobile data terminal does not have any self-positioning capabilities, and optionally provides other information (e.g., a telephone number or instant messaging ID of the mobile devices 114 and/or 120 in FIG. 1) that is used by the mobile data server to infer the current location of the mobile data terminal. In some embodiments, the user of the mobile data terminal optionally manually enters a zip code or a name of a location as the current location for the mobile data terminal, and the zip code or location name is sent to the mobile data server in the instruction execution request. In some embodiments, as will be described in more detail below, the mobile data server is capable of handling the different ways that location information may be obtained and verified for a mobile data terminal.

FIG. 3C is a flow chart for an exemplary process for controlling a mobile data terminal (e.g., a mobile POS terminal). In some embodiments, the process shown in FIG. 3C is performed by a mobile data server 100, or an operation server 104 of the mobile data server 100 in FIG. 1. In some embodiments, the process is optionally implemented by the operation control module 218 shown in FIG. 2.

As shown in FIG. 3C, the operation server receives (S320) an instruction execution request from the mobile POS terminal, the instruction execution request specifying an operation instruction generated at the mobile POS terminal. For example, the instruction execution request optionally includes a request to execute a credit card payment transaction, a coupon cashing transaction, a cash withdrawal transaction, an account transfer transaction, a payment acknowledgment transaction, a delivery confirmation transaction, etc. In some embodiments, an operator or customer of the mobile data terminal provides the necessary information and input to the mobile POS terminal (e.g., by swiping a payment card, providing a selection input on a suitable user interface element (e.g., a “buy” button), etc.) to trigger the generation of the instruction execution request. Once the instruction execution request is generated at the mobile POS terminal, it is then sent to the mobile data server (e.g., the operation server 104 in FIG. 1) for authorization and execution. In some embodiments, the mobile POS terminal transmits the instruction execution request through one or more wireless networks, such as a WiFi network, GSM network, a wireless telephony network, a CDMI network, etc.

In some embodiments, in response to receiving the instruction execution request, the mobile data server (e.g., the operation server) determines (S322) whether the instruction execution request contains current location information associated with the mobile POS terminal. As set forth above, sometimes the mobile data terminal does not necessarily have a self-positioning capability. In some embodiments, if the mobile data terminal does not have the self-positioning capability, the mobile data terminal does not send its location information with the instruction execution request. In some embodiments, if the mobile data terminal does not have the self-positioning capability, but sends the instruction execution request via a cellular network to the operation server, the instruction execution request optionally includes an identifier of a nearby base station that the mobile data terminal relied on for transmitting the instruction execution request. The mobile data server is optionally configured to determine the location of the base station using the identifier and to use the location of the base station as a rough location for the mobile data terminal. In some embodiments, the mobile data terminal includes the region number or cell number of the nearby base station in the instruction execution request. In some embodiments, the mobile data terminal has a self-positioning capability, e.g., using GPS, AGPS, or triangulation within the cellular network, in such a case, the mobile data terminal optionally determines its current location and includes the current location information (e.g., geo-coordinates) in the instruction execution request. In some embodiments, the operation or customer optionally provides a zip code or name of their current location to the mobile data terminal, and mobile data terminal optionally includes the zip code or the name of the current location in the instruction execution request. Sometimes, the location information provided in the instruction execution request may be inaccurate due to deliberate tampering, and/or equipment flaws. Due to the high variability in the way location information may be handled by the mobile data terminals that communicate with the mobile data server, the mobile data server handles the instruction execution request differently in accordance with whether location information is present in the instruction execution request, and in accordance with the particular form that the location information has taken.

As shown in FIG. 3C, in accordance with a determination that the instruction execution request does not contain current location information associated with the mobile POS terminal (S324): the mobile data terminal executes (S326) a real-time location acquisition procedure to proactively obtain the current location information associated with the mobile POS terminal. For example, in some embodiments, if the mobile data terminal does not have self-positioning capabilities, and the operator or customer has not manually entered any current location information, the instruction execution request will not include any current location information for the mobile data terminal. In addition, in some embodiments, a timestamp is attached to the location information in the instruction execution request, and if the timestamp indicates that the location information is not sufficiently up-to-date, the mobile data server optionally determines that the instruction execution request does not include current location information associated with the mobile POS terminal. When the mobile data server does not obtain current location information of the mobile POS terminal from the instruction execution request, the mobile data server proactively obtains the current location information through other means. By proactively obtaining the location information, the mobile data server is able to obtain location information that is more up-to-date. In addition, by obtaining the location information through a third-party, or using a secure and impartial process, the location information is less likely to be inaccurate due to tampering.

As shown in FIG. 3C, in accordance with a determination that the instruction execution request contains current location information associated with the mobile POS terminal (S328): the mobile data server executes (330) a real-time location verification procedure to confirm the current location information contained in the instruction execution request. In some embodiments, when the location information is proactively obtained by the mobile data server, a real-time verification process is not necessary. However, if the location information is provided by the mobile data terminal in the instruction execution request, then a real-time location verification process helps to ensure the accuracy of the location information.

In some embodiments, once the current location of the mobile data terminal has been obtained and/or verified, the mobile data server determines (S332) whether the mobile POS terminal is located in a pre-determined region according to the current location information that has been verified or proactively obtained. In some embodiments, in accordance with a determination that the mobile POS terminal is not currently located within the pre-determined region, the mobile data server declines (S334) to execute the requested operation instruction. In some embodiments, in accordance with a determination that the mobile POS terminal is currently located within the pre-determined region, the mobile data server initiates (S336) execution of the requested operation instruction.

In some embodiments, in accordance with a determination that the mobile POS terminal is not located in the pre-determined region, the mobile data server sends a remedial message to the mobile data terminal, where the remedial message contains instructions to an operator of the mobile POS terminal for reviving the instruction execution request. For example, the remedial message optionally describes a more stringent authorization process that the operator can take to revive the instruction execution request. The more stringent authorization process optionally includes a call to a supervisor or entry of a special passcode provided by a commerce or legal authority, etc. In some embodiments, the remedial message notifies the operator that he or she is outside of a permitted region for the requested operation, and asks the operator to resend the request when he or she has returned to the permitted region.

In some embodiments, in accordance with a determination that the mobile POS terminal is not located in the pre-determined region, the mobile data server sends an alert message to a monitoring authority regarding the instruction execution request. For example, if illegal transaction is suspected, the mobile data server automatically sends an alert to the law enforcement, such that the transaction can be logged and investigated timely. In some embodiments, the alert is sent to the monitoring authority without the knowledge of the operator or customer using the mobile data terminal.

As set forth above, sometimes, a mobile data terminal has a self-positioning capability (e.g., through built-in or external GPS module). In some embodiments, movement of the mobile POS terminal is monitored by a location server (e.g., the location server 106 in FIG. 1) using a positioning device coupled to the mobile POS terminal. When the instruction execution request does not include the current location of the mobile data terminal, the mobile data server optionally contacts the location server to obtain the most up-to-date location information for the mobile data terminal. In some embodiments, the mobile data server contacts a third-party location server to obtain a current location of the mobile POS terminal, where the current location has been verified by the location server to be consistent with a location history of the mobile POS terminal. For example, if the location information provided by the mobile data terminal to the location server shows unexplained gaps in time or distance, the location server determines that the positioning system coupled to the mobile data terminal is no longer accurate, and will notify the mobile data server that current location of the mobile data terminal is not available, or that the location history does not agree with the current location sent by the mobile POS terminal. In some embodiments, location of the mobile data terminal is monitored by the location server in real-time, and the mobile data terminal provides its current location to the mobile data server in the instruction execution request. In such embodiments, the mobile data server optionally verifies the current location included in the instruction execution request with the location server, such that any tampering of the location in the instruction execution request may be discovered in light of the location history stored by the location server.

FIG. 3D is a flow chart of an exemplary process for executing a real-time location acquisition procedure. In this exemplary location acquisition process, the mobile data server utilizes a mobile device (e.g., a mobile telephone device 114 or mobile device 120 in FIG. 1) which is associated with either the operator or the customer of the mobile data terminal, and which likely to be located in close physical proximity to the mobile data terminal, to determine the location of the mobile data terminal. Once the location information has been obtained from the mobile device, the mobile data server executes a proximity verification process to ensure that the location of the mobile device is the same as the location of the mobile data terminal.

As shown in FIG. 3D, in some embodiments, the mobile data server contacts (S340) a mobile telephony device associated with the mobile POS terminal to obtain a current location of the mobile telephony device. Once the mobile telephony device establishes communication with the mobile data server, the mobile data server requests and obtains from the mobile telephony device the current location of the mobile telephony device. In various embodiments, the mobile telephony device optionally determines its own location based on any available technology (e.g., GPS, AGPS, triangulation using locations of nearby base stations, etc.). In various embodiments, the communication between the mobile telephony device and the mobile data server may be realized using any available communication protocols, e.g., a telephone call, an SMS, a WiFi broadcast message, etc. In some embodiments, the mobile data server determines the contact address of the mobile telephony device based on information (e.g., an operator ID number, a customer ID number, a telephone number, or other suitable unique addresses or ID numbers) provided in the instruction execution request.

As shown in FIG. 3D, in some embodiments, once the mobile data server obtains the current location of the mobile telephony device from the mobile telephony device, the mobile data server executes (S342) a real-time proximity verification procedure to verify physical proximity of the mobile telephony device to the mobile POS device. In some embodiments, the mobile data server uses (S344) the current location of the mobile telephony device as the current location of the mobile POS terminal upon verifying the physical proximity of the mobile telephony device to the mobile POS device.

In some embodiments, the mobile telephony device associated with the mobile POS terminal is a cellular telephone of a customer identified in the instruction execution request. In some embodiments, the mobile telephony device associated with the mobile POS terminal is a cellular telephone of an operator identified in the instruction execution request.

In some embodiments, the proximity verification process is selectively omitted for low-risk transaction. In some embodiments, the location acquisition from the mobile telephony device is helpful to ensure that the accuracy of the location information, even if the mobile data terminal has provided its current location in the instruction execution request. In some embodiments, the customer's telephony device is preferred over the operator's telephony device by the mobile data server, when both are available.

FIG. 3E is a flow chart of an exemplary process for performing real-time proximity verification. As shown in FIG. 3E, in some embodiments, when executing the real-time proximity verification procedure, the mobile data server generates (S350) respective encoded information for the instruction execution request. In some embodiments, encoded information is a randomly generated passphrase. In some embodiments, the encoded information is an image. In some embodiments, the encoded information is a barcode that is difficult to decipher and alter by a human user. In some embodiments, the passphrase, the image, and/or the barcode encodes information (e.g., IDs, time, location, transaction type, etc.) associated with the mobile data terminal and the instruction execution request.

In some embodiments, the mobile data server sends (S352) a verification message to the mobile telephony device, the verification message containing the respective encoded information and requesting a recipient of the verification message to return the respective encoded information using mobile POS terminal within a predetermined time window. In some embodiments, once the mobile telephony device receives the verification message from the mobile data server, the mobile telephony device immediately displays the verification message to a user of the mobile telephony device, e.g., the operator or the customer. In some embodiments, according to the instructions displayed to the user, the user enters the encoded information into the mobile data terminal, e.g., by typing in the passcode, transmit the image via BlueTooth™, or allow the mobile data terminal to scan the barcode. In some embodiments, the encoded information is optionally an encoded signal (e.g., a waveform or pulse), and the encoded signal can be provided to the mobile data terminal using a nearfield transmission method (e.g., using a BlueTooth™, infrared, or optical transmission method).

In some embodiments, the mobile data server receives (S354) the respective encoded information from the mobile POS terminal within the predetermined time window. In response to receiving the respective encoded information from the mobile POS terminal within the predetermined time window, the mobile data terminal examines and verifies (S356) the validity of the respective encoded information to determine whether the mobile telephony device and the mobile POS device are located in close physical proximity to each other. For example, if the encoded information is correctly transmitted back to the mobile data sever from the mobile data terminal, the mobile data server determines that the physical proximity of the mobile data terminal and the mobile telephony device is confirmed. If no encoded information is received within the predetermined time window, or if the received encoded information has been altered or tampered with, the mobile data server determines that the physical proximity of the mobile data terminal and the mobile telephony device cannot be confirmed, and the current location of the mobile telephony device cannot be used as the current location of the mobile data terminal.

In some embodiments, when executing the real-time location verification procedure to confirm the current location information contained in the instruction execution request, the mobile data server uses the above location acquisition method to independently verify the location information contained in the instruction execution request received from the mobile data terminal FIG. 3F is a flow chart of an exemplary process for a real-time location verification process performed by the mobile data server.

In some embodiments, the mobile data server obtains (S360) a telephone number of a mobile telephony device associated with the mobile POS terminal. In some embodiments, the mobile telephony device is a smartphone carried by the customer. In some embodiments, the mobile telephony device is a smartphone carried by the operator of the mobile data terminal.

In some embodiments, the mobile data sever contacts (S362) the mobile telephony device associated with the mobile POS terminal to obtain a current location of the mobile telephony device. In some embodiments, the mobile data server (S364) compares the current location of the mobile telephony device and the current location information contained in the instruction execution request to determine if they match.

In some embodiments, when executing the real-time location verification procedure to confirm the current location information contained in the instruction execution request, in accordance with a determination that the current location of the mobile telephony device matches the current location information contained in the instruction execution request, the mobile data server executes (S366) a real-time proximity verification procedure to verify physical proximity of the mobile telephony device to the mobile POS device. In some embodiments, the mobile data server validates (S368) the current location information contained in the instruction execution request upon verifying the physical proximity of the mobile telephony device to the mobile POS device. In some embodiments, in accordance with a determination that the current location of the mobile telephony device does not match the current location information contained in the instruction execution request, or that the physical proximity of the mobile telephony device to the mobile POS device cannot be verified, the mobile data server invalidates (S370) the current location information contained in the instruction execution request.

In some embodiments, if the location information invalidated, the mobile data server also generates (S372) an alert message regarding the instruction execution request. In some embodiments, the mobile data server sends the alert message to the mobile POS terminal when the current location of the mobile POS does not pass the real-time location verification procedure. In some embodiments, the mobile data server sends the alert message to a monitoring authority when the current location of the mobile POS does not pass the real-time location verification procedure.

Although the location acquisition and verification processes described above indicates that the mobile telephony device of either the operator or the customer may be used. In some embodiments, for high-security transactions, the mobile data server optionally requires simultaneous and cooperative actions to be performed by both the operator and the customer on their respective mobile telephony devices. For example, the mobile data server optionally sends different parts of an encoded message (e.g., barcode, image, passphrase) to operator and the customer, and requires a complete encoded message to be assembled from the different parts at the mobile data terminal and returned to the mobile data server.

As set forth above, the mobile data server determines whether to execute a requested operation based on whether the requesting mobile data terminal is currently located within a pre-determined region (e.g., a region in which the mobile data terminal has been licensed or pre-authorized to perform the requested operation). In some embodiments, the detailed steps for executing the requested operation may differ depending on the current location of the mobile data terminal even if the requested operation is authorized. For example, different authorization process, different information, different tax rates, different prices, different discounts, etc. are optionally applied within different sub-regions of the pre-determined region.

In some embodiments, in accordance with a determination that the mobile POS terminal is located in the pre-determined region, the mobile data server executes the operation instruction in accordance with a current location of mobile POS terminal. For example, if the current location is within a first sub-region of the pre-determined region, a first price, tax rate, or discount rate is applied; and if the current location is within a second sub-region of the pre-determined region, a second price, tax rate, or discount rate is applied.

In some embodiments, the mobile data server generates location-specific service recommendations based on a current location of the mobile POS terminal. For example, coupons or advertisements of businesses that are near the current location of the mobile POS terminal are identified from a location based service (LBS) database. In some embodiments, the mobile data server optionally only identifies service recommendations that are related to the current business transaction occurring at the mobile data terminal. For example, if the customer makes a purchase from a food truck, the mobile data server optionally provides information on nearby parks in which the user can sit and have lunch.

In some embodiments, the mobile data server sends the location-specific service recommendations to the mobile POS terminal in a confirmation message for successful execution of the operation instruction. For example, when a receipt of the transaction is provided back to the mobile data terminal. The location-specific service recommendations are optionally printed on the receipt or displayed with the receipt at the mobile data terminal.

In some embodiments, the mobile data server generates location-specific service recommendations based on a current location of the mobile POS terminal; and instead of or in additional to sending them to the mobile data terminal, the mobile data server optionally sends the location-specific service recommendations to a mobile telephony device of a customer associated with the instruction execution request. For example, while the customer is waiting for the requested transaction to be completed by the mobile data server, the customer can review the service recommendations provided by the mobile data server on his or her own mobile telephony device. The customer can also choose to save the coupons delivered to his or her mobile telephony device from the mobile data server.

In some embodiments, the mobile data server ceases to send the location-specific service recommendations when a confirmation message for successful execution of the operation instruction has been sent to the mobile POS terminal. In some embodiments, the mobile data sever continues to send more of the location-specific service recommendations to the mobile telephony device of the customer until the customer issues an explicit input to stop the transmission of the recommendations.

FIG. 3G is a flow chart of an example process for sending location-based service information to the mobile data terminal. As shown in FIG. 3G, in some embodiments, after the above-mentioned step S308 or S340, the mobile data server further performs the following steps:

In some embodiments, in Step S380, the mobile data server invokes a network application for a location based service, and generating location based service information according to the location information of the mobile data terminal.

In some embodiments, when executing the operation instruction, a network application for the location based service (LBS) will also be invoked so as to provide location based services (e.g., map information, location-based service recommendations, traffic information, directions, etc.) according to the location information of the mobile data terminal. The location based service information generated by the network application for the location based service can be information relevant to the location information, for example, information about food, living facilities, etc. near the geographical location corresponding to the location information of the mobile data terminal.

In some embodiments, in Step S382, the mobile data server sends back to the mobile data terminal the execution result of the operation instruction and the location based service information.

In some embodiments, after the execution of the operation instruction is completed, the execution result and the generated location based service information are sent back to the mobile data terminal to facilitate the mobile data terminal in outputting the corresponding execution result and location based service information. For example, after completing a card-swiping payment, the mobile data terminal will output execution results such as the payment amount, payment time, etc. in the form of a printed receipt, and will print the location based service information on the back of the printed receipt.

The above-mentioned method for controlling a mobile data terminal also provides a function of the location based service for the mobile data terminal according to the location information, after securely executing the input operation instruction. This provides further convenience for the user.

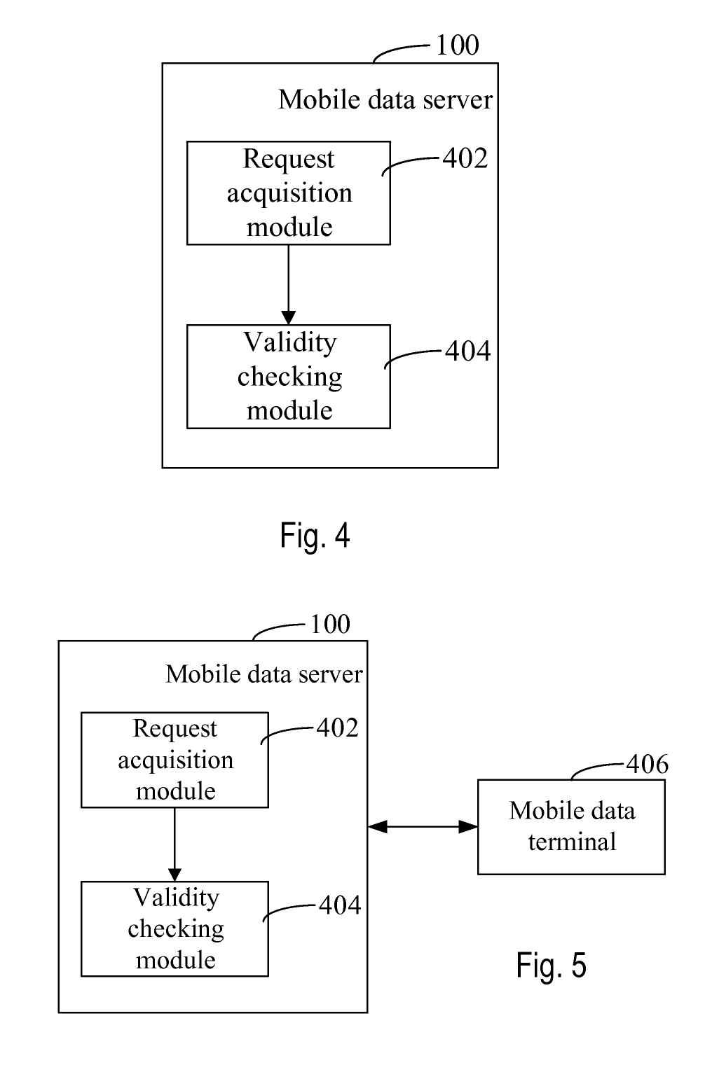

As shown in FIG. 4, in some embodiments, a system for controlling a mobile data terminal comprises a mobile data server 100.

In some embodiments, the mobile data server 100 comprises a request acquisition module 402 (shown as module 220 in FIG. 2) and a validity checking module 404 (shown as module 222 in FIG. 2).

In some embodiments, the request acquisition module 402 is used for acquiring an instruction execution request from a mobile data terminal, with the instruction execution request comprising an operation instruction triggered by the mobile data terminal and, optionally, location information of the mobile data terminal.

In some embodiments, the instruction execution request comprises an operation instruction triggered by the mobile data terminal and location information thereof. The request acquisition module 402 acquires the instruction execution request initiated by the mobile data terminal, and then identifies an operation input provided by the mobile data terminal according to the operation instruction in the instruction execution request. The request acquisition module 402 then obtains the location where the mobile data terminal is located according to the location information of the mobile data terminal contained in the instruction execution request.

In some embodiments, the location information contained in the instruction execution request is used for identifying the location where the mobile data terminal is currently located. In some embodiments, a positioning function is added into the mobile data terminal to acquire the location information about the place where the mobile data terminal is currently located so that monitoring of the location of the mobile data terminal is performed.

As shown in FIG. 5, in some embodiments, the above-mentioned system for controlling a mobile data terminal further comprises:

A mobile data terminal 406 for obtaining the longitude and latitude of the place where the mobile data terminal is located by carrying out positioning thereof with a satellite positioning system provided on the mobile data terminal. In some embodiments, the mobile data terminal 406 initiates the instruction execution request according to the operation instruction triggered at the mobile data terminal and the longitude and latitude.

In some embodiments, a satellite positioning module is provided in the mobile data terminal 406. The satellite positioning module is externally connected to or provided in the mobile data terminal, thus achieving the positioning of the mobile data terminal by means of the satellite positioning system provided by the satellite positioning module. Particularly, the satellite positioning system can be the global positioning system or the assisted global positioning system. The location information obtained by means of the satellite positioning system is the longitude and latitude of the place where the mobile data terminal is located.

In some embodiments, in the process of actual operation, the mobile data terminal 406 regularly positions the mobile data terminal to obtain the location information thereof, and uploads the location information to a database (e.g., a location information database of the location server 106 in FIG. 1) in the background.

In some embodiments, an operation instruction is generated through an input for a card-swiping payment operation or other operations such as a pre-authorization operation, etc. provided at the mobile data terminal 406. At this moment, the mobile data terminal 406 packages the longitude and latitude obtained by the current positioning and the operation instruction to generate an instruction execution request, so as to initiate the instruction execution request to the mobile data server 100 on the backend.

In some embodiments, the mobile data terminal 406 is also used for obtaining the region number of the region where the mobile data terminal is located through the communication in a mobile communication network, and initiating the instruction execution request according to the operation instruction triggered by the mobile data terminal and the region number.

In some embodiments, if the mobile data terminal 406 is a mobile terminal, then when the mobile data terminal 406 is communicating through a mobile communication network, the mobile data terminal first registers with a nearby base station. Since each base station has corresponding region signal information, in this communication process, the mobile terminal needs to register to the base station so as to acquire the region signal information such as the corresponding operator, region number, etc. Through communicating with the base station, the mobile data terminal can transmit the communication data to a switch of the mobile communication network. Therefore, the mobile terminal acquires the region number of the region where the mobile terminal is located through the communication in the mobile communication network, and identifies the location where the mobile terminal is located by taking the region number as location information.

In some embodiments, the mobile data terminal 406 generates an operation instruction through an operation input on the mobile terminal, and packages the currently acquired region number and the operation instruction to obtain an instruction execution request, so as to initiate the instruction execution request to a mobile data server on the backend.

In some embodiments, the validity checking module 404 is used for judging whether the mobile data terminal is located in a pre-determined region according to the location information in the instruction execution request. If the validity checking module determines that the mobile data terminal is not located in the pre-determined region, the validity checking module declines or refuses to execute the operation instruction; and if the validity checking module determines that the mobile data terminal is located within the predetermined region, the validity checking module executes the operation instruction.

In some embodiments, the pre-determined region is a pre-determined region for which the use of the mobile data terminal has been authorized. After receiving the instruction execution request initiated by the mobile data terminal, the mobile data server 100 will judge the validity of the operation input by the mobile data terminal so as to determine whether the input operation occurs in the pre-determined region. In accordance with the location information, if it is judged that the location, where the mobile data terminal is located when inputting the operation, is located in the pre-determined region, then it indicates that the input operation is valid. The mobile data server is allowed to execute the corresponding operation instruction. If the mobile data server 100 judges that the location, where the mobile terminal is located when inputting the operation, is not located in the pre-determined region, the execution of the corresponding operation instruction will be forbidden in order to reduce the risk.

In some embodiments, the mobile data server 100 is also used for judging whether the mobile data terminal is located in the pre-determined region directly according to the location information thereof after the mobile data terminal is positioned and the location information thereof is obtained. In some embodiments, if the mobile data terminal is not located within the pre-determined region, the mobile data server will generate alarm information and send the alarm information back to the mobile data terminal 406. In some embodiments, if the mobile data terminal is located within the pre-determined region, the mobile data sever informs the mobile data terminal 406 to continue positioning the mobile data terminal.

In some embodiments, monitoring of the mobile data terminal is achieved according to the location information, so as to further improve the security of the mobile data terminal.

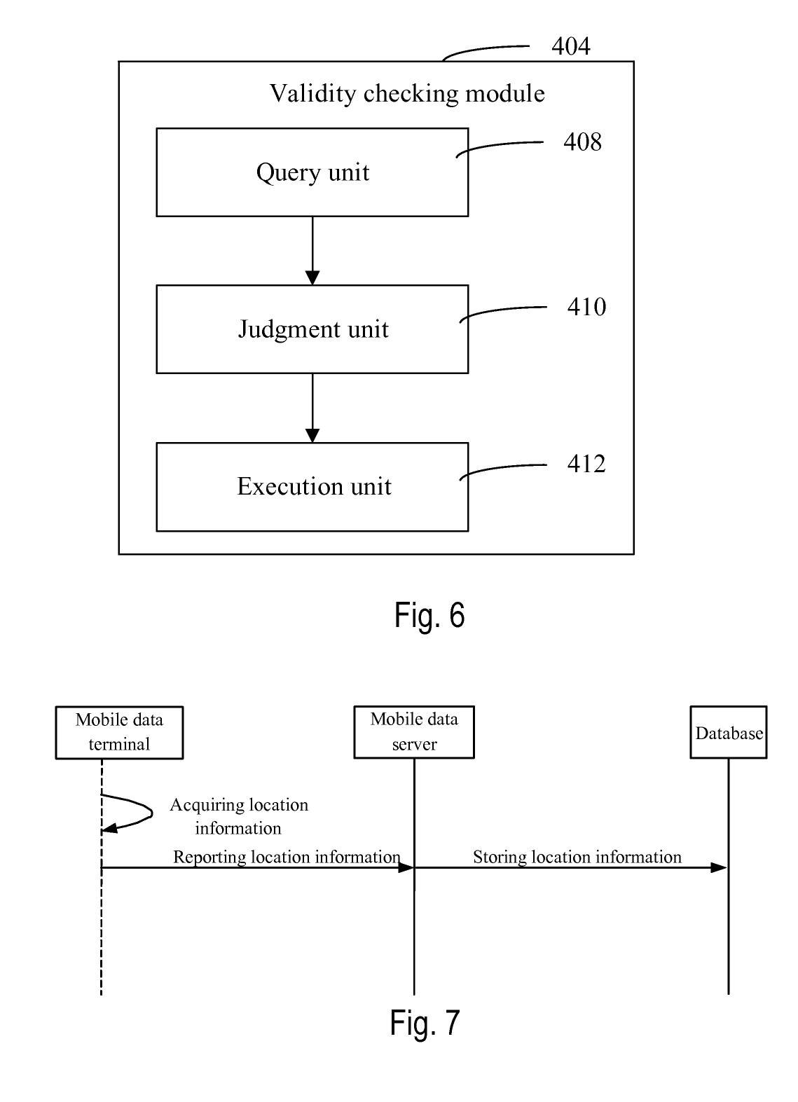

As shown in FIG. 6, in some embodiments, the above-mentioned validity checking module 404 comprises a query unit 408, a judgment unit 410 and an execution unit 412.

In some embodiments, the query unit 408 is used for making a query about the geographical location corresponding to the region number.

In some embodiments, if the mobile data terminal is a mobile terminal, then the corresponding location information can be in the form of region number. Correspondingly, when judging the validity of the input of the mobile data terminal according to the location information, the query unit 408 will achieve the same according to the region number, and obtain the geographical location corresponding to the region number according to the region number.

In some embodiments, the judgment unit 410 is used for judging whether the geographical location is located in a pre-determined region, and if not, the mobile data server refuses to execute the operation instruction, and if yes, the mobile data server informs the execution unit 412.

In some embodiments, the judgment unit 410 judges whether the mobile terminal is located in the pre-determined region according to the geographical location, thus learning whether the mobile terminal is located in a pre-determined region in which the use of the mobile terminal has been pre-authorized.

In some embodiments, the execution unit 412 is used for executing the operation instruction.

In some embodiments, the above-mentioned system for controlling a mobile data terminal further comprises a network application server.

In some embodiments, the network application server is used for invoking a network application for a location based service, and generating location based service information according to the location information.

In some embodiments, when executing the operation instruction, the network application server 50 will also invoke a network application for the location based service so as to provide location based services according to the location information. The location based service information generated by a network application for the location based service can be information relevant to the location information, for example, information about food, living facilities, etc. near the geographical location corresponding to the location information.

In some embodiments, the above-mentioned mobile data server 100 further comprises a transmission module, with the transmission module being used for sending back to the mobile data terminal the execution result of the operation instruction and the location based service information.

In some embodiments, after the execution of the operation instruction is completed, the transmission module sends back the execution result and the generated location based service information to the mobile data terminal to facilitate the mobile data terminal in outputting the corresponding execution result and location based service information. For example, after completing a card-swiping payment transaction, the mobile data terminal will output execution results such as the payment amount, payment time, etc. in the form of a printed receipt, and will print the location based service information on the back of the printed receipt.

In some embodiments, the above-mentioned method for controlling a mobile data terminal also provides a function of the location based service for the mobile data terminal 406 according to the location information after securely executing the input operation instruction, further providing convenience for the user.

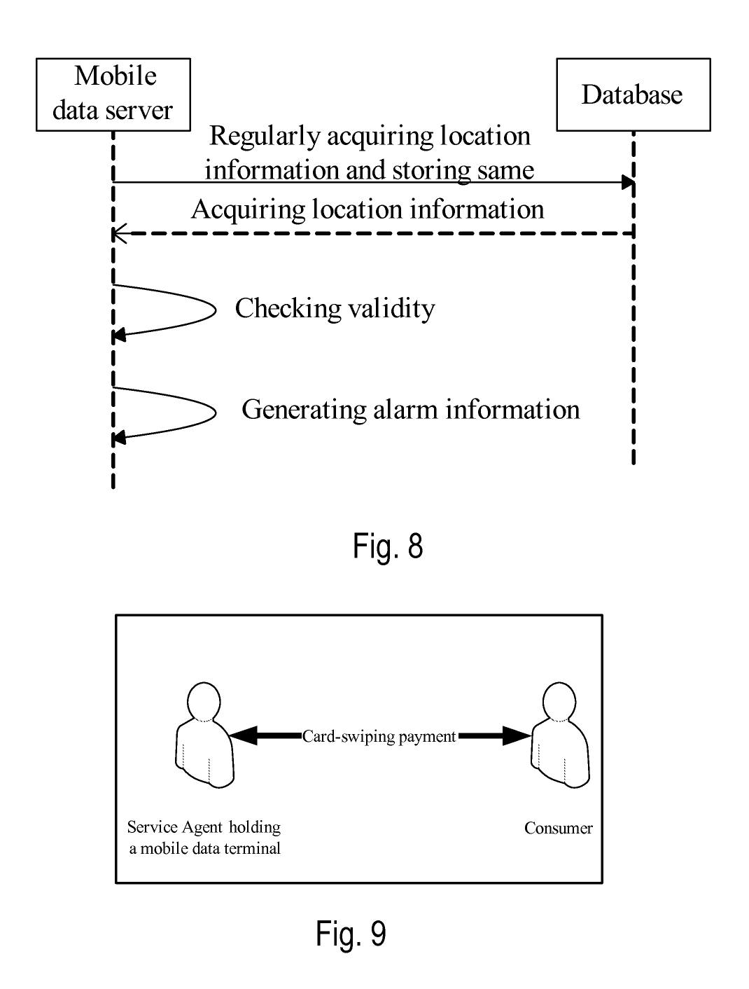

A specific example application will be provided below to describe the above-mentioned method and system for controlling a mobile data terminal in detail. In some embodiments, as shown in FIG. 7, the mobile data terminal 406 regularly performs the self-positioning function to obtain its own current location. The mobile data terminal uploads and stores the obtained location information in a database (e.g., a location database of the location server 106 in FIG. 1) of the mobile data server 100. As shown in FIG. 8, the mobile data server 100 checks the validity of the location information stored in the database and judges whether the mobile data terminal 406 is located in a pre-determined region, and if not, the mobile data server 100 generates alarm information and displays the alarm information through a web page, an email or a short message, thus realizing monitoring of the mobile data terminal 406.

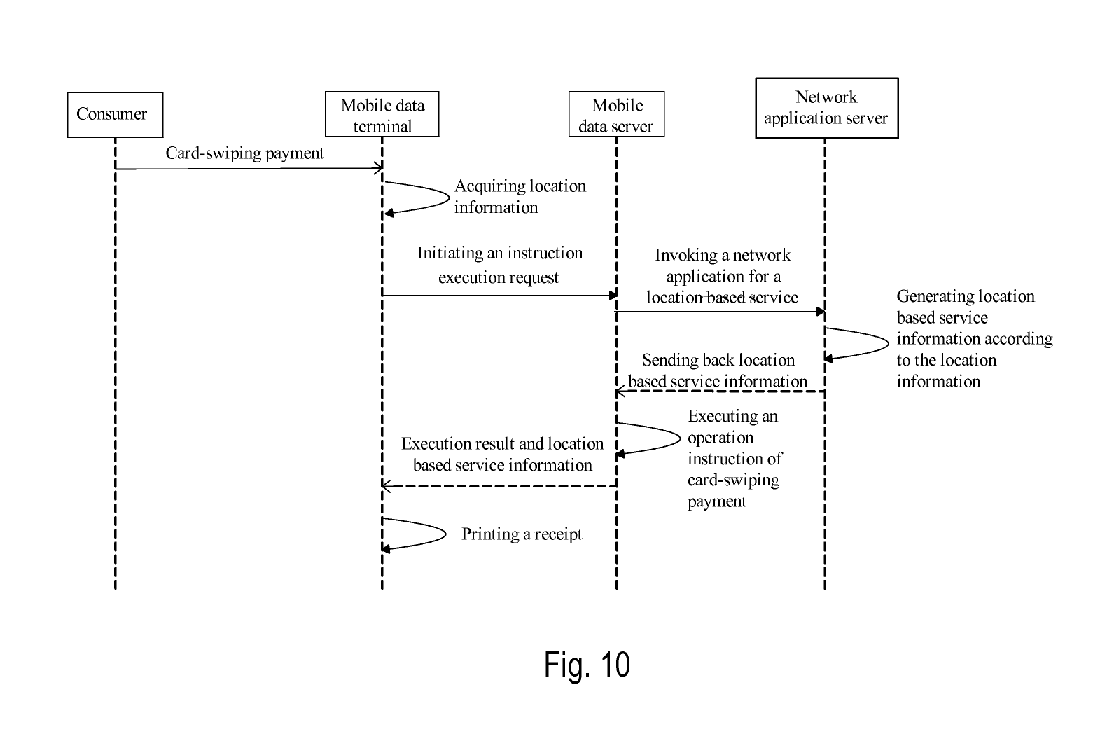

As shown in FIG. 9, a service agent and a consumer inputs a card-swiping payment operation to the mobile data terminal. As shown in FIG. 10, the mobile data terminal 406 initiates an instruction execution request according to a card-swiping payment operation instruction and the current location information. After receiving the initiated instruction execution request, the mobile data server 100 will judge whether the mobile data terminal 406 is located in a pre-determined region according to the location information in the instruction execution request. If it is judged that the mobile data terminal 406 is not in the pre-determined region, the mobile data server 100 refuses to execute the card-swiping payment operation. If it is judged that the mobile data server 406 is in the pre-determined region, the mobile data server 100 invokes a network application for a location based service through a network application server, when executing the card-swiping payment operation. The network application server generates location based service information and sends the same back to the mobile data server 100. At this moment, the transmission module of the mobile data server 100 will send back to the mobile data terminal 406 the execution result of the operation instruction and location based service information, so that the mobile data terminal 406 can proceed to print a receipt including the execution result and the location based service information.

The above-mentioned method and system for controlling a mobile data terminal include, after acquiring the location information about the place where the mobile data terminal is currently located, initiating an instruction execution request according to a triggered operation instruction and the location information, and then judging whether the location where the mobile data terminal is currently located is in a pre-determined region, according to the location information in the instruction execution request. If the mobile data terminal is not currently located within the pre-determined region, then the operation instruction will not be executed, so as to reduce the risk that the mobile data terminal moves to another region for performing other purposes departing from the original authorized purposes. Monitoring of the mobile data terminal according to the location information also improves security.

Those skilled in the art would understand that the whole or a part of the flow for realizing the method in the above-mentioned embodiments can be achieved by instructing relevant hardware by a computer program, wherein the program can be stored in a computer readable storage medium. When the program is being executed, the flow of the method of the above-mentioned various embodiments can be included therein. The storage medium can be a diskette, an optical disk, a read-only memory (ROM) or a random access memory (RAM), etc.

The above-mentioned embodiments only describe several implementation methods of the present invention. The description thereof is relatively specific and detailed, but it should not be understood as restrictions to the patent scope of the present invention. It should be noted that for those skilled in the art, several transformations and improvements can also be made without departing from the concept of the present invention, and these all belong to the scope of protection of the present invention. Therefore, the scope of protection of the present invention patent should be based on the appended claims.

What is claimed is:

1. A method for controlling a mobile point-of-sale (POS) terminal, comprising:
at a device having one or more processors and memory:
receiving an instruction execution request from the mobile POS terminal, the instruction execution request specifying an operation instruction generated at the mobile POS terminal;
in response to receiving the instruction execution request, determining whether the instruction execution request contains current location information associated with the mobile POS terminal;
in accordance with a determination that the instruction execution request does not contain current location information associated with the mobile POS terminal:
executing a real-time location acquisition procedure to proactively obtain the current location information associated with the mobile POS terminal;
in accordance with a determination that the instruction execution request contains current location information associated with the mobile POS terminal:
executing a real-time location verification procedure to confirm the current location information contained in the instruction execution request; and
determining whether the mobile POS terminal is located in a pre-determined region according to the current location information that has been verified or proactively obtained.

2. The method of claim 1, further comprising:
in accordance with a determination that the mobile POS terminal is not located in the pre-determined region, declining to execute the requested operation instruction.

3. The method of claim 1, wherein executing the real-time location acquisition procedure further comprises:
contacting a mobile telephony device associated with the mobile POS terminal to obtain a current location of the mobile telephony device;
executing a real-time proximity verification procedure to verify physical proximity of the mobile telephony device to the mobile POS device; and
using the current location of the mobile telephony device as a current location of the mobile POS terminal upon verifying the physical proximity of the mobile telephony device to the mobile POS device.

4. The method of claim 3, wherein the mobile telephony device associated with the mobile POS terminal is a cellular telephone of a customer identified in the instruction execution request.

5. The method of claim 1, wherein executing the real-time location verification procedure to confirm the current location information contained in the instruction execution request further comprises:
obtaining a telephone number of a mobile telephony device associated with the mobile POS terminal;
contacting the mobile telephony device associated with the mobile POS terminal to obtain a current location of the mobile telephony device; and
comparing the current location of the mobile telephony device and the current location information contained in the instruction execution request.

6. The method of claim 1, further comprising:
in accordance with a determination that the mobile POS terminal is located in the pre-determined region, executing the operation instruction in accordance with a current location of mobile POS terminal.

7. The method of claim 1, further comprising:
generating location-specific service recommendations based on a current location of the mobile POS terminal; and
sending the location-specific service recommendations to the mobile POS terminal in a confirmation message for successful execution of the operation instruction.

8. A non-transitory computer-readable medium having instructions stored thereon, the instructions, when executed by one or more processors, cause the processors to perform operations comprising:
at a device having one or more processors and memory:
receiving an instruction execution request from a mobile POS terminal, the instruction execution request specifying an operation instruction generated at the mobile POS terminal;
in response to receiving the instruction execution request, determining whether the instruction execution request contains current location information associated with the mobile POS terminal;
in accordance with a determination that the instruction execution request does not contain current location information associated with the mobile POS terminal:
executing a real-time location acquisition procedure to proactively obtain the current location information associated with the mobile POS terminal;
in accordance with a determination that the instruction execution request contains current location information associated with the mobile POS terminal:
executing a real-time location verification procedure to confirm the current location information contained in the instruction execution request; and
determining whether the mobile POS terminal is located in a pre-determined region according to the current location information that has been verified or proactively obtained.

9. The computer-readable medium of claim 8, wherein the operations further comprise:
in accordance with a determination that the mobile POS terminal is not located in the pre-determined region, declining to execute the requested operation instruction.

10. The computer-readable medium of claim 8, wherein executing the real-time location acquisition procedure further comprises:
contacting a mobile telephony device associated with the mobile POS terminal to obtain a current location of the mobile telephony device;
executing a real-time proximity verification procedure to verify physical proximity of the mobile telephony device to the mobile POS device; and
using the current location of the mobile telephony device as a current location of the mobile POS terminal upon verifying the physical proximity of the mobile telephony device to the mobile POS device.

11. The computer-readable medium of claim 10, wherein the mobile telephony device associated with the mobile POS terminal is a cellular telephone of a customer identified in the instruction execution request.

12. The computer-readable medium of claim 8, wherein executing the real-time location verification procedure to confirm the current location information contained in the instruction execution request further comprises:
obtaining a telephone number of a mobile telephony device associated with the mobile POS terminal;
contacting the mobile telephony device associated with the mobile POS terminal to obtain a current location of the mobile telephony device; and
comparing the current location of the mobile telephony device and the current location information contained in the instruction execution request.

13. The computer-readable medium of claim 8, wherein the operations further comprise:
in accordance with a determination that the mobile POS terminal is located in the pre-determined region, executing the operation instruction in accordance with a current location of mobile POS terminal.

14. The computer-readable medium of claim 8, wherein the operations further comprise:
generating location-specific service recommendations based on a current location of the mobile POS terminal; and
sending the location-specific service recommendations to the mobile POS terminal in a confirmation message for successful execution of the operation instruction.

15. A system, comprising:
one or more processors; and
memory having instructions stored thereon, the instructions, when executed by the one or more processors, cause the processors to perform operations comprising:
receiving an instruction execution request from a mobile POS terminal, the instruction execution request specifying an operation instruction generated at the mobile POS terminal;
in response to receiving the instruction execution request, determining whether the instruction execution request contains current location information associated with the mobile POS terminal;
in accordance with a determination that the instruction execution request does not contain current location information associated with the mobile POS terminal:
executing a real-time location acquisition procedure to proactively obtain the current location information associated with the mobile POS terminal;
in accordance with a determination that the instruction execution request contains current location information associated with the mobile POS terminal:
executing a real-time location verification procedure to confirm the current location information contained in the instruction execution request; and
determining whether the mobile POS terminal is located in a pre-determined region according to the current location information that has been verified or proactively obtained.

16. The system of claim 15, wherein the operations further comprise:
in accordance with a determination that the mobile POS terminal is not located in the pre-determined region, declining to execute the requested operation instruction.

17. The system of claim 15, wherein executing the real-time location acquisition procedure further comprises:
contacting a mobile telephony device associated with the mobile POS terminal to obtain a current location of the mobile telephony device;
executing a real-time proximity verification procedure to verify physical proximity of the mobile telephony device to the mobile POS device; and
using the current location of the mobile telephony device as a current location of the mobile POS terminal upon verifying the physical proximity of the mobile telephony device to the mobile POS device.

18. The system of claim 15, wherein executing the real-time location verification procedure to confirm the current location information contained in the instruction execution request further comprises:
obtaining a telephone number of a mobile telephony device associated with the mobile POS terminal;
contacting the mobile telephony device associated with the mobile POS terminal to obtain a current location of the mobile telephony device; and
comparing the current location of the mobile telephony device and the current location information contained in the instruction execution request.

19. The system of claim 15, wherein the operations further comprise:
in accordance with a determination that the mobile POS terminal is located in the pre-determined region, executing the operation instruction in accordance with a current location of mobile POS terminal.

20. The system of claim 15, wherein the operations further comprise:
generating location-specific service recommendations based on a current location of the mobile POS terminal; and
sending the location-specific service recommendations to the mobile POS terminal in a confirmation message for successful execution of the operation instruction.
